(19) United States
(12) Patent Application Publication
(10) Pub. No.: US 2024/0278254 A1
(43) Pub. Date: Aug. 22, 2024

(54) COMBINED DIRECT-DRIVE ENERGY-EFFICIENT SAND MILL

(71) Applicant: Guangdong Hongkai Intelligent Technology Co., Ltd.,, Guangzhou City (CN)

(72) Inventors: Xun LIU, Guangzhou City (CN); Zhiyong TAN, Guangzhou City (CN); Bo YANG, Guangzhou City (CN)

(21) Appl. No.: 18/469,963

(22) Filed: Sep. 19, 2023

(30) Foreign Application Priority Data
Feb. 21, 2023 (CN) 202310142794.4

(51) Int. Cl. B02C 17/24; B02C 17/10; B02C 17/18

(52) U.S. Cl. CPC B02C 17/24; B02C 17/10; B02C 17/1805; B02C 2210/01

(57) ABSTRACT

The disclosure discloses a direct-drive sand mill. In various embodiments, the direct-drive sand mill includes: a motor assembly operable to be electrically powered to generate a rotation around a motor rotor rotation axis, a sand mill main body configured to perform a sanding operation, a main shaft configured to extend from the motor assembly to the sand mill main body and to include a shaft section inside the sand mill main body, the main shaft being coaxially aligned with the motor rotor, main shaft support devices positioned at different locations along the main shaft to support the main shaft to coaxially align the motor rotor rotation axis of the motor assembly to the sand mill main body, and multiple flatness detection assemblies positioned at different locations along the main shaft to detect whether the main shaft shifts with respect to the axis of the main shaft.

### PRIORITY CLAIM AND RELATED PATENT APPLICATION

This patent document claims priority to and benefits of Chinese Patent Application No. 202310142794.4 entitled “COMBINED DIRECT-DRIVE ENERGY-EFFICIENT SAND MILL” and filed on Feb. 21, 2023, which is incorporated by reference as part of the disclosure of this patent document.

### TECHNICAL FIELD

The present disclosure relates to the technical field of sand mills, and more particularly, to a combined direct-drive energy-efficient sand mill.

### BACKGROUND

Sand mills, also known as bead mills, are mainly used for wet grinding of liquid chemical products. According to their operational characteristics and performance, sand mills can be roughly divided into horizontal sand mills, basket sand mills, and vertical sand mills. A sand mill is mainly formed of a machine body, a grinding cylinder, a sanding disc (shift lever), a grinding medium, a motor, and a feed pump. The speed of feeding is controlled by the feed pump. Grinding media of such devices are generally divided into zirconia beads, glass beads, zirconium silicate beads, and so on.

In a conventional sand mill, the drive motor and the cylinder are separate components. When in use, a motor shaft of the drive motor drives a rotating shaft inside the cylinder to rotate the cylinder through a transmission belt and a transmission pulley group to perform a sanding operation. Thus, there may be a non-concentric misalignment between the shafts that are coupled with each other, which may cause noise and vibrations, thus reducing the stability and reliability of the sand mill.

### SUMMARY

One objective of the present disclosure is to provide a combined direct-drive energy-efficient sand mill, capable of addressing the aforementioned problem of lowering the stability and reliability of the sand mill.

In order to achieve the above objective, the present disclosure provides the following technical solution. A combined direct-drive energy-efficient sand mill includes: a main engine assembly, a motor assembly installed on a left end surface of the main engine assembly, and a sand mill main body installed on a right end surface of the main engine assembly. The interior of the sand mill main body has a mounting frame; the interior of the main engine assembly, the interior of the motor assembly, and a middle part of the mounting frame are rotatably coupled to a main shaft to achieve coaxiality of the motor assembly, the main engine assembly, and the sand mill main body. The motor assembly drives the main shaft to rotate, thus enabling the sand mill main body to perform a sanding operation. The outer wall of the main shaft is sequentially covered and equipped with a first flatness detection assembly, a third flatness detection assembly, and a second flatness detection assembly, each being configured to detect whether the main shaft shifts.

The above first flatness detection assembly includes an annular slide groove assembly, a rotatable shell assembly rotatably arranged around the annular slide groove assembly, and a plurality of slide column detection assemblies slidably arranged on a left side of the annular slide groove assembly. The plurality of the slide column detection assemblies are located between the rotatable shell assembly and the annular slide groove assembly and each has one end protruding toward the rotatable shell assembly. The rotatable shell assembly is configured to rotate to drive the plurality of slide column detection assemblies to move towards the main shaft on the left side of the annular slide groove assembly, enabling the plurality of slide column detection assemblies to detect whether the main shaft shifts during operation, so as to determine whether the main shaft wears.

In some preferred implementations, the rotatable shell assembly may further include a through-hole concave housing, a first annular limiting body being welded on a right inner wall of the through-hole concave housing, and a plurality of limiting arc grooves being annularly distributed on a left end surface of the through-hole concave housing.

In some preferred implementations, the annular slide groove assembly may further include an inner annular support body, the inner annular support body being located inside the through-hole concave housing, a left end surface of the inner annular support body being in contact with a left inner wall of the through-hole concave housing, an annular limiting plate being welded on an outer wall of a middle part of the inner annular support body, a right end surface of the annular limiting plate being in contact with a left end surface of the first annular limiting body, the left end surface of the inner annular supporting body having a plurality of annularly distributed recesses, and the inner annular support body having a plurality of stepped round holes to receive bolts.

In some preferred implementations, each slide column detection assembly may further include a square column, the square column being slidably connected to a recess, the square column having a fixed groove at a middle part of one end of the square column, a circular tube being fixedly connected inside the fixed groove, a film being fixedly connected in a middle inside the circular tube, a conductive disc being provided at a middle part of the film, conductive columns being provided on both sides of an upper surface of the conductive disc, a contact switch being provided on an inner wall of the circular tube away from the drive main shaft, the contact switch being located directly above the conductive disc, an airbag being provided at one end of the circular tube close to the drive main shaft, the airbag communicating with the circular tube, a circular shaft being welded on a side of a left end surface of the square column away from the drive main shaft, and the circular shaft extending out of the limiting arc groove and being slidable inside the limiting arc groove.

In some preferred implementations, the airbag may be filled with gas, an annular red line may be provided at a middle part of an outer wall of the circular tube, and the film may be flush with the annular red line.

In some preferred implementations, the third flatness detection assembly and the second flatness detection assembly may have same components as the first flatness detection assembly, and the first flatness detection assembly, the third flatness detection mechanism, and the second flatness detection assembly may be installed by bolts on a left end surface of main engine assembly, a right inner wall of the main engine assembly, and a left end surface of mounting frame, respectively.

In some preferred implementations, the drive motor assembly for a sand mill may include a stator housing, a connecting flange being welded at a right end of the stator housing, a rotor winding being rotatably connected inside the stator housing, the rotor winding being arranged around a left outer wall of the main shaft, and an auxiliary support being provided at a lower end of the stator housing.

In some preferred implementations, a sand mill controller may be provided on the sand mill main body, an alarm may be installed on the sand mill controller, and the sand mill controller may be electrically connected with the contact switch, two conductive columns, the stator housing, and the alarm, respectively. The sand mill controller, the contact switch, the conductive disc, and the alarm may collectively operate to control the alarm to generate an alarm signal when the two conductive columns contact two contacts on the contact switch.

In comparison with certain prior art sand mill designs, the present disclosure provides a combined direct-drive energy-efficient sand mill which provides the following advantageous effects.
1. In the present disclosure, no output shaft of the drive motor is provided in the sand mill and the drive motor shares the main shaft of the cylinder of the sand mill, which optimizes the design of the drive unit, simplifies the manufacturing process, avoids the problem of non-concentricity between shafts that are coupled, thereby solving the problem of noise and vibrations, and improving the stability and reliability of the device.
2. In the present disclosure, with the clockwise rotation of the through-hole concave housing in the inner annular supporting body, a plurality of limiting arc grooves may be driven to rotate and to drive a plurality of square columns, through a plurality of circular shafts, to move inside a plurality of recesses towards the main shaft. When a plurality of airbags contact the outer wall of the main shaft, a plurality of slide column detection assemblies start to monitor the main shaft. When the main shaft wears and shifts, the airbag(s) in the shifting direction may be squeezed, such that the gas inside the airbag(s) enter(s) the circular tube and push(es) the film to deform. The greater the deformation of the film is, the greater the wear of the main shaft may be. When the two conductive columns on the conductive disc contact the two contacts of the main shaft, the sand mill controller on the sand mill main body may control the alarm to generate an alarm signal, notifying an operator to replace the main shaft in time to avoid damage to the motor assembly. In addition, the third flatness detection assembly and the second flatness detection assembly have the same components as the first flatness detection assembly, and the first flatness detection assembly, the third flatness detection assembly, and the second flatness detection assembly are arranged around the main shaft in order from left to right. Therefore, the degree of wear of the main shaft can be fully detected and the detection accuracy can be improved.

### BRIEF DESCRIPTION OF THE DRAWINGS

The accompanying drawings are used to provide further understanding of the present disclosure, constitute a part of the description, and are used to explain, rather than limit, the present disclosure together with the embodiments of the present disclosure, in which:

FIG. 1 is a schematic diagram showing a structure of a combined direct-drive energy-efficient sand mill according to the present disclosure;

FIG. 2 is a schematic diagram showing a front view of the structure of FIG. 1 with the sand mill main body removed;

FIG. 3 is a schematic diagram showing a three-dimensional composition structure of a first flatness detection assembly;

FIG. 4 is a schematic diagram showing an exploded three-dimensional structure of FIG. 3;

FIG. 5 is a schematic diagram showing a three-dimensional structure of another viewing angle of FIG. 4;

FIG. 6 is a schematic diagram showing a front view of a structure of a detection column;

FIG. 7 is a schematic diagram showing an enlarged structure of Part A of FIG. 6;

FIG. 8 is a schematic diagram showing a bottom view of the structure of FIG. 6 with the airbag removed;

FIG. 9 is a schematic diagram showing a top view of a structure of a film;

FIG. 10 is a schematic diagram showing a structure of FIG. 7 in another working state;

FIG. 11 is a schematic diagram showing an enlarged structure of Part B of FIG. 10;

FIG. 12 is a schematic diagram showing a structure according to the present disclosure.

In the figures: 1. connecting flange; 2. first flatness detection assembly; 21. rotatable shell assembly; 2101. limiting arc groove; 2102. through-hole concave housing; 2103. first annular limiting body; 22. annular slide groove assembly; 2201. inner annular support body; 2202. annular limiting plate; 2203. stepped round hole; 2204. recess; 23. slide column detection assembly; 2301. circular shaft; 2302. square column; 2303. airbag; 2304. fixed groove; 2305. contact switch; 2306. film; 2307. circular tube; 2308. conductive disc; 2309. conductive column; 3. stator housing; 4. rotor winding; 5. main shaft; 6. auxiliary support; 7. second flatness detection assembly; 8. mounting frame; 9. sand mill main body; 10. third flatness detection assembly; 11. main engine assembly; 12. motor assembly with a motor rotor rotation axis 13.

### DETAILED DESCRIPTION OF THE EMBODIMENTS

Some embodiments of the present disclosure disclose a combined direct-drive energy-efficient sand mill. In various embodiments, the combined direct-drive energy-efficient sand mill includes: a main engine assembly, a motor assembly installed on a left end surface of the main engine assembly, and a sand mill main body installed on a right end surface of the main engine assembly. The interior of the sand mill main body is furnished with a mounting frame, an interior of the main engine assembly, an interior of the motor assembly, and a middle part of the mounting frame are rotatably coupled to a main shaft to achieve coaxiality of the motor assembly, the main engine assembly, and the sand mill main body. The motor assembly is configured to drive the main shaft to rotate to enable the sand mill main body to perform a sanding operation. An outer wall of the main shaft is sequentially covered and equipped with a first flatness detection assembly, a third flatness detection assembly, and a second flatness detection assembly, each being configured to detect whether the main shaft shifts. The motor is not equipped with an output shaft, and the motor shares the main shaft of the cylinder of the sand mill, which optimizes the design of the drive unit, simplifies the manufacturing process, avoids the problem of non-concentricity when shafts are connected, thereby solving the problem of noise and vibration, and improving the stability and reliability of the device.

In the following, the solutions according to the embodiments of the present disclosure will be described clearly and completely with reference to the figures. Obviously, the embodiments described below are only some, rather than all, of the embodiments of the present disclosure. All other embodiments that can be obtained by those skilled in the art based on the embodiments described in the present disclosure without any inventive efforts are to be encompassed by the scope of the present disclosure.

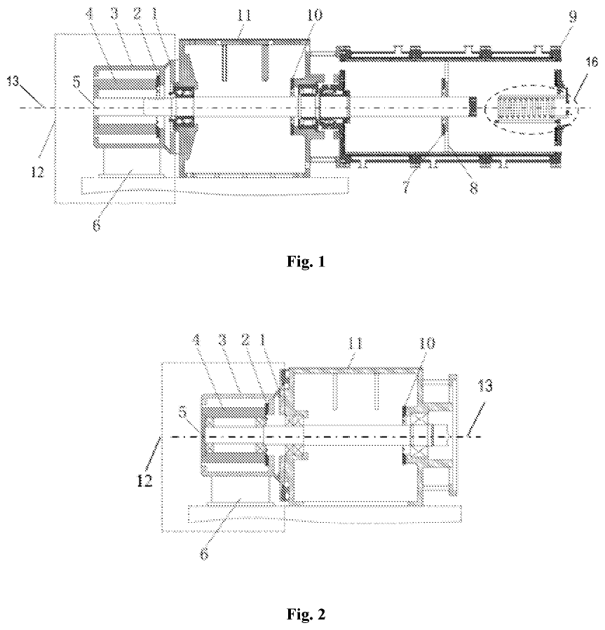

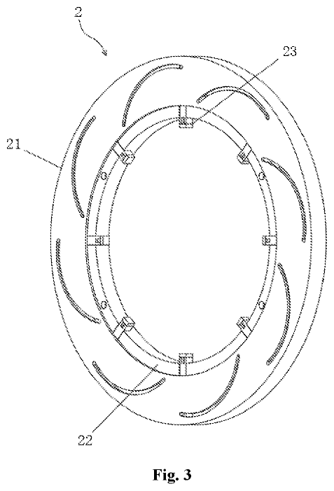

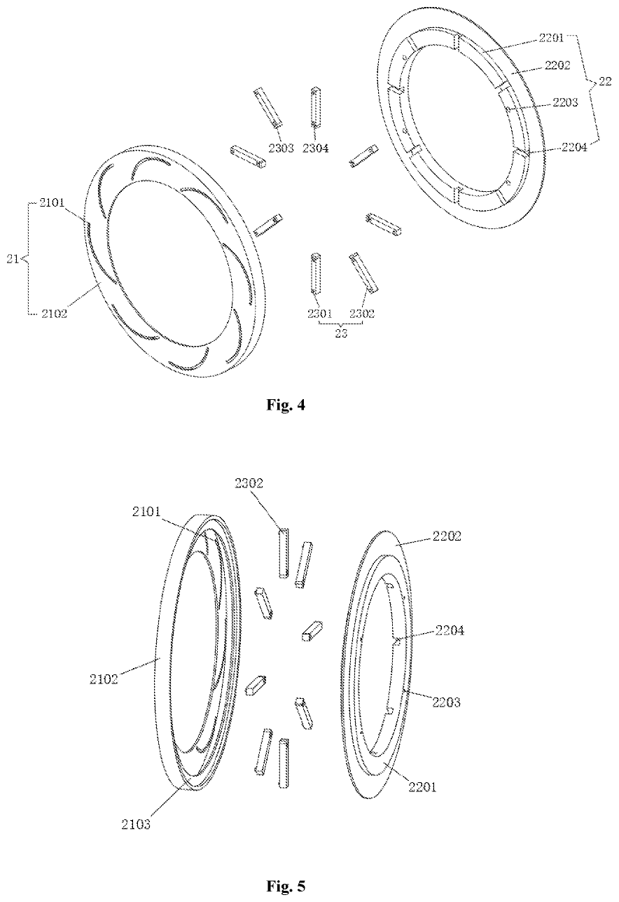

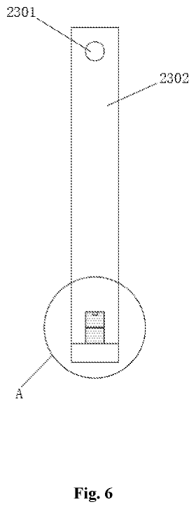

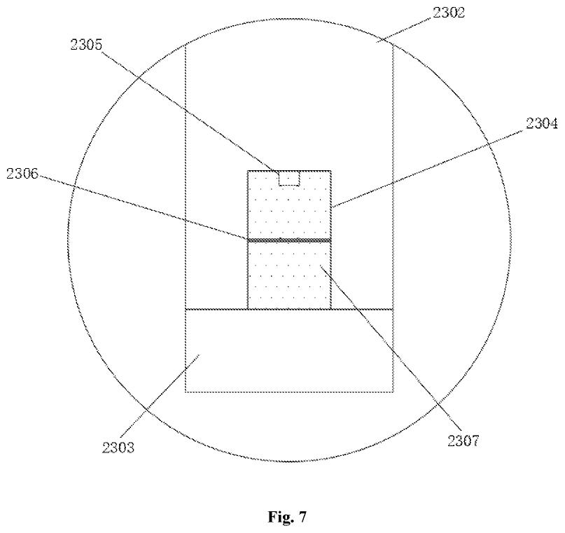

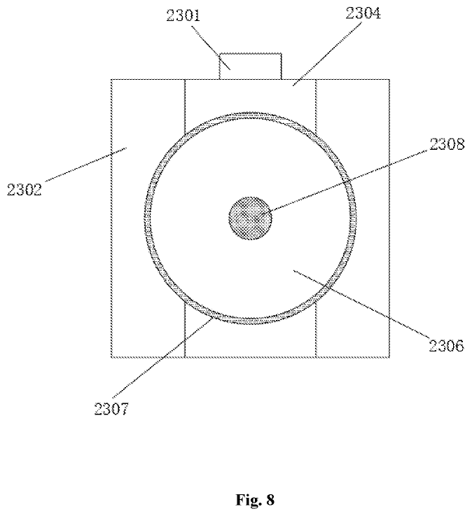

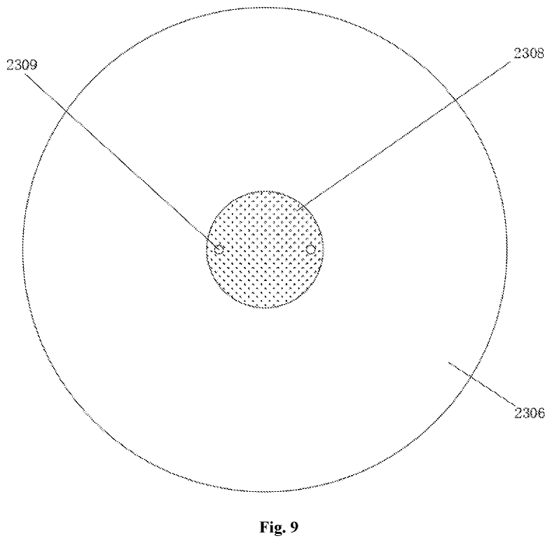

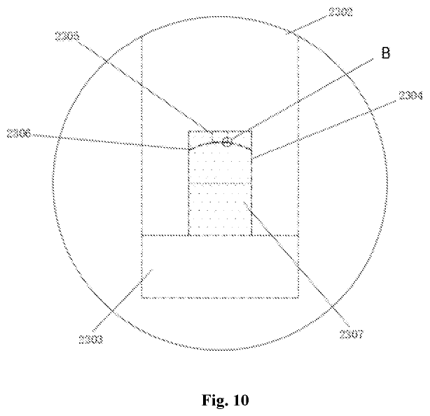

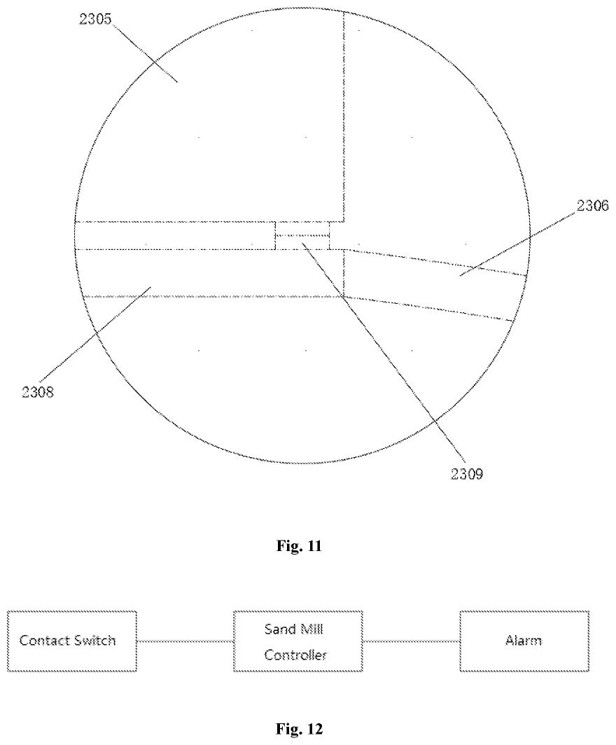

Referring to FIGS. 1-12, the present disclosure provides a technical solution. A combined direct-drive energy-efficient sand mill includes: a main engine assembly 11, a motor assembly 12 installed on a left end surface of the main engine assembly 11 that includes a motor rotor that rotates around a motor rotor rotation axis 13, and a sand mill main body 9 installed on a right end surface of the main engine assembly 11, and a main shaft 5 (e.g., a cylindrical rod shaft) that extends from the motor assembly 12 through the main engine assembly 11 into the sand mill main body 9 to engage to a rotating module inside the sand mill main body 9 so that the rotation of the main shaft 5 rotates the rotating module within the sand mill main body 9. An interior of the sand mill main body 9 is furnished with a mounting frame 8 to support the main shaft 5 which can rotate relative to the mounting frame 8. An interior of the main engine assembly 11, an interior of the motor assembly 12, and a middle part of the mounting frame 8 are rotatably coupled to, and to hold and support, the main shaft 5 to achieve coaxiality of the motor assembly 12, the main engine assembly 11, and the sand mill main body 9. The rotating module within the sand mill main body 9 is coaxially engaged to a shaft section of the main shaft 5 that extends into the sand mill main body 9 to rotate with the main shaft 5 inside the sand mill main body 9 for performing the grinding and sanding operation. In some implementations, for example, the rotating module inside the sand mill main body 9 may include a rotating rod-pin type rotor with protruding pins extending radially outward that rotatably impact the mixture of a material to be grinded and a grinding medium supplied into the sand mill main body 9 for the grinding and sanding operation. The motor assembly 12's rotator coaxially drives the main shaft 5 to rotate to enable the sand mill main body 9 to perform the grinding and sanding operation. The sand mill main body 9 may be furnished with a cooling coil module 16 to remove heat generated during a grinding or sanding operation with the rotating module (e.g., a rotating rod-pin type rotor) within the sand mill main body 9 in part to reduce undesired deformation of the main shaft 5 at elevated temperatures. The cooling coil module 16 may be mounted on the shaft section of the main shaft 5 within the sand mill main body 9. Merely by way of example, the cooling coil module 16 may be mounted at an end portion of the main shaft 5 that is opposite the motor assembly 12, as illustrated in FIG. 1. The cooling coil module 16 may be configured to cool or reduce the temperature of the main shaft 5 and/or a material object being processed in the sand mill main body 9.

An outer wall of the main shaft 5 is sequentially covered and equipped, from left to right, with a first flatness detection assembly 2, a third flatness detection assembly 10, and a second flatness detection assembly 7, each being configured to detect whether the main shaft 5 shifts. The first flatness detection assembly 2 includes an annular slide groove assembly 22, a rotatable shell assembly 21 rotatably arranged around the annular slide groove assembly 22, and a plurality of slide column detection assemblies 23 slidably arranged on a left side of the annular slide groove assembly 22. The plurality of the slide column detection assemblies 23 are located between the rotatable shell assembly 21 and the annular slide groove assembly 22 and each has one end protruding toward the rotatable shell assembly 21. The rotatable shell assembly 21 rotates to drive the plurality of slide column detection assemblies 23 to move towards the main shaft 5 on the left side of the annular slide groove assembly 22, enabling the plurality of slide column detection assemblies 23 to detect whether the main shaft 5 shifts during operation, so as to determine whether the main shaft 5 wears. The rotatable shell assembly 21 further includes a through-hole concave housing 2102. A first annular limiting body 2103 is welded on a right side of an inner wall of the through-hole concave housing 2102, and a plurality of limiting arc grooves 2101 are annularly distributed on a left end surface of the through-hole concave housing 2102. The annular slide groove assembly 22 further includes an inner annular support body 2201. The inner annular support body 2201 is located inside the through-hole concave housing 2102. A left end surface of the inner annular support body 2201 is in contact with a left inner wall of the through-hole concave housing 2102. An annular limiting plate 2202 is welded on an outer wall of a middle part of the inner annular support body 2201. A right end surface of the annular limiting plate 2202 is in contact with a left end surface of the first annular limiting body 2103. The left end surface of the inner annular supporting body 2201 has a plurality of annularly distributed recesses 2204. The inner annular support body 2201 has a plurality of stepped round holes 2203 for bolts to pass through. Each slide column detection assembly 23 further includes a square column 2302. The square column 2302 is slidably connected to a recess 2204. A fixed groove 2304 is provided at a middle part of one end of the square column 2302. A circular tube 2307 is fixedly connected inside the fixed groove 2304. A film 2306 is fixedly connected in a middle inside the circular tube 2307. A conductive disc 2308 is provided at a middle part of the film 2306. Conductive columns 2309 are provided on both sides of an upper surface of the conductive disc 2308. A contact switch 2305 is provided on an inner wall of the circular tube 2307 away from the drive main shaft 5. The contact switch 2305 is located directly above the conductive disc 2308. An airbag 2303 is provided at one end of the circular tube 2307 close to the drive main shaft 5. The airbag 2303 communicates with the circular tube 2307. A circular shaft 2301 is welded on a side of a left end surface of the square column 2302 away from the drive main shaft 5. The circular shaft 2301 extends out of the limiting arc groove 2101 and slides inside the limiting arc groove 2101. The airbag 2303 is filled with gas. An annular red line is provided at a middle part of an outer wall of the circular tube 2307. The film 2306 is flush with the annular red line.

As shown in FIG. 1 and FIG. 2, the third flatness detection assembly 10 and the second flatness detection assembly 7 have same components as the first flatness detection assembly 2. The first flatness detection assembly 2, the third flatness detection assembly 10, and the second flatness detection assembly 7 are installed by bolts on a left end surface of the main engine assembly 11, a right inner wall of the main engine assembly 11, and a left end surface of mounting frame 8, respectively. The third flatness detection assembly 10 and the second flatness detection assembly 7 can detect whether the middle part and the right side of the main shaft 5 wears, so as to improve the detection accuracy.

As shown in FIG. 1 and FIG. 2, the motor assembly 12 includes a stator housing 3. A connecting flange 1 is welded at a right end of the stator housing 3. A rotor winding 4 is rotatably connected inside the stator housing 3 to rotate with respect to the stator housing 3. The rotor winding 4 is arranged around a left outer wall of the main shaft 5 and is coaxially engaged to the main shaft 5 so that the rotor winding 4 and the main shaft 5 rotate together coaxially around the motor rotor rotation axis 13 inside the stator housing 3 when the motor assembly 12 is electrically powered. An auxiliary support 6 is provided at a lower end of the stator housing 3 to provide additional support to the motor assembly 12. Under this design, the motor assembly 12 can provide driving power to cause a rotation of the main shaft 5, which is engaged to rotate the rotating module inside the sand mill main body 9, around the same motor rotor rotation axis 13 of the motor rotor within the motor assembly 12.

As shown in FIG. 12, a sand mill controller is provided on the sand mill main body 9. An alarm is installed on the sand mill controller. The sand mill controller is electrically connected with the contact switch 2305, two conductive columns 2309, the stator housing 3, and the alarm, respectively. The sand mill controller, the contact switch 2305, the conductive disc 2308, and the alarm collectively operate to control the alarm to generate an alarm signal when the two conductive columns 2309 contact two contacts on the contact switch 2305.

The working principle and use procedure of the present disclosure are as follows. Before use, an operator first places the entire device at a designated position, then connects the sand mill controller on the sand mill main body 9 to an external power supply, and then places a material object to be processed into the sand mill main body 9. After that, the operator rotates the through-hole concave housing 2102 clockwise, causing the through-hole concave housing 2102 to rotate clockwise in the inner annular support body 2201, thereby driving the plurality of limiting arc grooves 2101 to rotate, and through the plurality of circular shafts 2301, driving the plurality of square columns 2302 to move towards the main shaft 5 inside the plurality of recesses 2204, such that the plurality of airbags 2303 contact the outer wall of the main shaft 5. In this way, the plurality of slide column detection assemblies 23 may monitor the main shaft 5.

When in use, by operating the sand mill controller on the sand mill main body 9, the stator housing 3 may be powered on. After the stator housing 3 is powered on, a magnetic field may be generated by the stator housing 3. At this time, the rotor winding 4, after sensing the magnetic field generated by the stator housing 3, may drive the main shaft 5 to rotate, such that the sand mill main body 9 may grind the material object to be processed.

During the grinding process, when the main shaft 5 wears and shifts, it may squeeze the airbag 2303 in the shifting direction, such that the gas inside the airbag 2303 enters the circular tube 2307, and pushes the film 2306 to deform. The greater the deformation of the film 2306 is, the greater the wear of the main shaft 5 may be. When the two conductive columns 2309 on the conductive disc 2308 contact the two contacts of the main shaft 5, the sand mill controller 2309 on the sand mill main body 9 may control the alarm to go off, notifying the operator to replace the main shaft 5 in time. Since the third flatness detection assembly 10 and the second flatness detection assembly 7 have the same components as the first flatness detection assembly 2, and the first flatness detection assembly 2, the third flatness detection assembly 10, and the second flatness detection assembly 7 are arranged around the main shaft 5 in order from the left to the right. Therefore, the degree of wear of the main shaft 5 can be fully detected and the detection accuracy can be improved.

While the embodiments of the present disclosure have been shown and described, those skilled in the art can understand that various changes, modifications, alternatives, and variants can be made to these embodiments without departing from the principle and spirit of the present disclosure.

What is claimed is:

1. A combined direct-drive energy-efficient sand mill, comprising:
a main engine assembly,
a motor assembly installed on a left end surface of the main engine assembly, and
a sand mill main body installed on a right end surface of the main engine assembly, wherein:
an interior of the sand mill main body is furnished with a mounting frame,
an interior of the main engine assembly, an interior of the motor assembly, and a middle part of the mounting frame are rotatably coupled to a main shaft to achieve coaxiality of the motor component, the main engine assembly, and the sand mill main body,
the motor assembly is configured to drive the main shaft to rotate to enable the sand mill main body to perform a sanding operation,
an outer wall of the main shaft is sequentially covered and equipped with, from left to right, a first flatness detection assembly, a third flatness assembly, and a second flatness detection assembly, each being configured to detect whether the main shaft shifts,
the first flatness detection assembly comprises an annular slide groove assembly, a rotatable shell assembly rotatably arranged around the annular slide groove assembly, and a plurality of slide column detection assemblies slidably arranged on a left side of the annular slide groove assembly, the plurality of the slide column detection assemblies being positioned between the rotatable shell assembly and the annular slide groove assembly, and each having one end protruding toward the rotatable shell assembly,
the rotatable shell assembly is configured to rotate to drive the plurality of slide column detection assemblies to move towards the main shaft from the left side of the annular slide groove assembly, enabling the plurality of slide column detection assemblies to detect whether the main shaft shifts during operation, so as to determine whether the main shaft wears.

2. The combined direct-drive energy-efficient sand mill according to claim 1, wherein the rotatable shell assembly further comprises a through-hole concave housing, a first annular limiting body being welded on a right inner wall of the through-hole concave housing, and a plurality of limiting arc grooves being annularly distributed on a left end surface of the through-hole concave housing.

3. The combined direct-drive energy-efficient sand mill according to claim 2, wherein the annular slide groove assembly further comprises an inner annular support body, the inner annular support body is located inside the through-hole concave housing, a left end surface of the inner annular support body is in contact with a left inner wall of the through-hole concave housing, an annular limiting plate is welded on an outer wall of a middle part of the inner annular support body, a right end surface of the annular limiting plate is in contact with a left end surface of the first annular limiting body, the left end surface of the inner annular supporting body has a plurality of annularly distributed recesses, and the inner annular support body has a plurality of stepped round holes to receive bolts.

4. The combined direct-drive energy -efficient sand mill according to claim 3, wherein each slide column detection assembly further comprises a square column, the square column being slidably connected to a recess, the square column having a fixed groove at a middle part of one end of the square column, a circular tube is fixedly connected inside the fixed groove, a film is fixedly connected in a middle part inside the circular tube, a conductive disc is provided at a middle part of the film, conductive columns are provided on both sides of an upper surface of the conductive disc, a contact switch is provided on an inner wall of the circular tube away from the drive main shaft, the contact switch being located directly above the conductive disc, an airbag is provided at one end of the circular tube close to the drive main shaft, the airbag communicating with the circular tube, and a circular shaft is welded on a side of a left end surface of the square column away from the drive main shaft, the circular shaft extending out of the limiting arc groove and being slidable inside the limiting arc groove.

5. The combined direct-drive energy-efficient sand mill according to claim 4, wherein the airbag is filled with gas, an annular red line is provided at a middle part of an outer wall of the circular tube, and the film is flush with the annular red line.

6. The combined direct-drive energy-efficient sand mill according to claim 5, wherein the third flatness detection assembly and the second flatness detection assembly have same components as the first flatness detection assembly, and the first flatness detection assembly, the third flatness detection assembly, and the second flatness detection assembly are installed by bolts on the left end surface of the main engine assembly, a right inner wall of the main engine assembly, and a left end surface of the mounting frame, respectively.

7. The combined direct-drive energy-efficient sand mill according to claim 6, wherein the motor assembly comprises a stator housing, a connecting flange welded at a right end of the stator housing, a rotor winding rotatably connected inside the stator housing, the rotor winding being arranged around a left outer wall of the main shaft, and an auxiliary support provided at a lower end of the stator housing.

8. The combined direct-drive energy-efficient sand mill according to claim 7, wherein a sand mill controller is provided on the sand mill main body, an alarm is installed on the sand mill controller, and the sand mill controller is electrically connected with the contact switch, the two conductive columns, the stator housing, and the alarm, respectively, and
wherein the sand mill controller, the contact switch, the conductive disc, and the alarm collectively operate to control the alarm to generate an alarm signal when the two conductive columns contact two contacts on the contact switch.

9. A direct-drive sand mill, comprising:
a motor assembly operable to be electrically powered to generate a rotation around a motor rotor rotation axis,
a sand mill main body configured to perform a sanding operation,
a main shaft configured to extend from the motor assembly to the sand mill main body and to include a shaft section inside the sand mill main body, the main shaft being coupled to the motor assembly such that an axis of the main shaft is coaxially aligned with the motor rotor rotation axis of the motor assembly and the main shaft coaxially rotates around the motor rotor rotation axis in performing the sanding operation via a rotation of the shaft section inside the sand mill main body,
main shaft support devices positioned at different locations along the main shaft to support the main shaft to coaxially align the motor rotor rotation axis of the motor assembly to the sand mill main body, wherein each main shaft support device is coupled to the main shaft to enable the main shaft to rotate coaxially with the motor rotor rotation axis of the motor assembly while being supported by each main shaft support device, and
a plurality of flatness detection assemblies positioned at different locations along the main shaft to detect whether the main shaft shifts, at the different locations, respectively, with respect to the axis of the main shaft which is coaxially aligned with the motor rotor rotation axis of the motor rotor of the motor assembly.

10. The direct-drive sand mill as in claim 9, wherein the main shaft support devices include a mounting frame fixedly attached to the sand mill main body, the shaft section of the main shaft inside the sand mill main body is rotatably supported on the mounting frame.

11. The direct-drive sand mill as in claim 9, each of the plurality of flatness detection assemblies comprising:
a plurality of slide column detection assemblies, wherein each of the plurality of slide column detection assemblies includes:
a column having an end region that opposes the main shaft for sensing a contact with the main shaft at a corresponding location of the column and is movable relative to the main shaft, and
a column detector coupled to the column and configured to produce a column detector output indicative of whether the main shaft shifts at a location of the column,
wherein the plurality of slide column detection assemblies collectively detect whether the main shaft shifts during the sanding operation.

12. The direct-drive sand mill as in claim 11, wherein each of the plurality of flatness detection assemblies includes:
an annular slide groove assembly that includes different annularly distributed recesses for respectively accommodating columns of the plurality of slide column detection assemblies to surround the main shaft, and
a rotatable shell assembly coupled to the annular slide groove assembly and the plurality of slide column detection assemblies, wherein the plurality of slide column detection assemblies are positioned between the rotatable shell assembly and the annular slide groove assembly.

13. The direct-drive sand mill as in claim 12, wherein, for each of the plurality of slide column detection assemblies of a flatness detection assembly,
the column of the slide column detection assembly includes a second end region opposite the end region that is structured to include a circular shaft which couples the slide column detection assembly to the rotatable shell assembly.

14. The direct-drive sand mill as in claim 13, wherein
the rotatable shell assembly includes a plurality of limiting arc grooves, and
the plurality of slide column detection assemblies are moveably coupled to the plurality of limiting arc grooves via the circular shafts of the columns of the slide column detection assembly, respectively.

15. The direct-drive sand mill as in claim 12, wherein:
the annular slide groove assembly includes a plurality of recesses, and
each of the plurality of slide column detection assemblies is moveably positioned within one of the plurality of recesses in which the slide column detection assembly is movable radially toward or away from the main shaft.

16. The direct-drive sand mill as in claim 11, wherein the column of a slide column detection assembly includes a fixed groove in which the detection sub-assembly of the slide column detection assembly is positioned.

17. The direct-drive sand mill as in claim 16, wherein:
the fixed groove includes an opening that opposes the main shaft and a base opposite the opening, and
each slide column detection assembly includes an airbag that opposes the main shaft through the opening of the fixed groove and a film that opposes the base of the fixed groove and deforms toward the base in reaction to an action of the airbag caused by a shift of the main shaft.

18. The direct-drive sand mill as in claim 17, wherein, each of the plurality of slide column detection assemblies includes a contact switch at the base of the fixed groove and one or more conductive columns engaged to the film, wherein the contact switch and the one or more conductive columns are separated from each other when a shift of the main shaft is less than a shift threshold and are in contact with each other when the shift exceeds the shift threshold to cause a deformation of the film toward the base that makes a contact between the contact switch and the one or more conductive columns.

19. The direct-drive sand mill as in claim 18, further comprising a sand mill controller coupled to be in communication with the column detectors in the plurality of slide column detection assemblies and configured to generate an alarm signal when a contact is detected by at least one of the column detectors in the plurality of slide column detection assemblies.

20. The direct-drive sand mill as in claim 9, further comprising a sand mill controller coupled to be in communication with the plurality of flatness detection assemblies positioned at different locations along the main shaft and configured to set off an alarm representing occurrence of an undesired shift in the main shaft.
